(19) United States
(12) Patent Application Publication
(10) Pub. No.: US 2026/0366559 A1
(43) Pub. Date: Nov. 19, 2026

(54) SCREW

(71) Applicant: AVVIO GmbH & Co KG, Graz (AT)

(72) Inventor: Gerhard HUBMANN, Graz (AT)

(21) Appl. No.: 19/477,891

(22) PCT Filed: Apr. 17, 2024
(86) PCT No.: PCT/AT2024/060156

§ 371 Date: Oct. 23, 2025

(30) Foreign Application Priority Data
Apr. 24, 2023 (AT) A 50306/2023

(51) Int. Cl. F16B 25/00; B21H 3/02

(52) U.S. Cl. CPC F16B 25/0078; B21H 3/02; F16B 25/0084; F16B 25/0015

(57) ABSTRACT

A screw comprising a screw head, a screw shaft and a substantially conical screw tip, the screw having a thread extending along the screw shaft towards the screw head, starting from the screw tip, wherein the screw has at least one elevation extending towards the screw shaft, starting from at least one point of the elevation which is frontmost in a screw-in direction of the screw, and has a course which corresponds to at least a section of an ellipse, the ellipse being arranged in a plane which intersects the screw shaft at an angle of between 15 degrees and 75 degrees, and with a height of the elevation being smaller than a height of the thread.

### BACKGROUND

The invention relates to a screw having the features of the preamble of claim 1, and to a rolling jaw according to claim 16.

Screws are widely used in the field of fastening technology and serve to firmly interconnect several objects. Thus, screws are used, for example, in the construction of buildings or furniture. Screws according to the prior art comprise a screw head, a screw shaft and a substantially conical screw tip. In addition, they have a thread extending along the screw shaft towards the screw head, starting from the screw tip.

The purpose of screws is to connect elements, which may be made of the same or of different materials. For example, screws for connecting elements made of wood are referred to as wood screws. Wood screws generally serve for fastening or connecting components made of wood or a wood-like material. For this purpose, they autonomously cut an appropriate mating thread into the material, which serves for the absorption of forces arising on the screw. Such wood screws are screwed into a component with their tip first, whereby the material of the component is displaced and sliced by the wood screw.

A key parameter for screws consists in the thread extraction force or, respectively, the pull-out capacity. This is the holding force which is provided by the screw thread screwed into the component for the connection of the components that have been screwed together. It is obvious that a screw should have a design which provides a high thread extraction force.

When screwing in a screw, the displaced material creates a pressure which acts both on the screw that has been screwed in and within the material of the component. This pressure can harmfully result in the component being blown up or destroyed when screwing-in takes place, due to a splitting effect of the screw that has been screwed in. Furthermore, the pressure created when screwing in leads to increased effort and/or an increased screw-in torque, which must be applied for bolting the screw. As a result, the disadvantage arises that an excessive screw-in torque can result in the screw being twisted as it is being screwed in, thus causing damage to the component. Furthermore, it is desirable for the screw to have a screw-out torque which exceeds the screw-in torque.

As screwing-in takes place, screws according to the prior art usually slice the fibres of the material of the component into which they are being screwed, whereby chips are produced. The latter remain in the mating thread cut into the material of the component by the screw. This causes the disadvantage that the screw-in torque is thereby increased and the thread extraction force and the screw-out torque are reduced at the same time.

### BRIEF SUMMARY

It is the object of the present invention to provide a screw and a rolling jaw for producing such a screw, which further improves the properties mentioned and avoids the disadvantages of the prior art.

According to the invention, the present object is achieved by providing a screw which comprises a screw head, a screw shaft and a substantially conical screw tip. In addition, the screw comprises a thread extending along the screw shaft towards the screw head, starting from the screw tip. According to the invention, the screw has at least one elevation extending towards the screw shaft, starting from at least one point of the elevation which is frontmost in a screw-in direction of the screw, and has a course which corresponds to at least a section of an ellipse. This ellipse is arranged in a plane which intersects the screw shaft at an angle of between 15 degrees and 75 degrees, with a height of the elevation being smaller than a height of the thread.

Because of the elevation, which has an elliptical course at least in sections, and its inclination relative to the screw shaft at an angle of between 15 degrees and 75 degrees, the advantage is obtained that a punching effect occurs when the screw is screwed into a component material such as wood, the punching effect preventing too strong a splitting effect from being created by the screw as it is being driven in. As a result, part of the fibres of the component material are punched out along a screw-in direction of the screw, whereby the component is effectively prevented from splitting as the screw is being screwed in.

The course of the elevation preferably forms an ellipse that is open against the screw-in direction. Alternatively, the course of the elevation forms an ellipse that is open in the screw-in direction. These configurations have the effect that dusty component material, such as, e.g., wood dust, will not accumulate within the ellipses, which could lead to an increased splitting effect and a higher screw-in torque.

According to an alternative embodiment variant of the screw according to the invention, the elevation has a course which corresponds to a complete ellipse. As a result, the punching effect of the screw according to the invention is improved, and the splitting effect is further reduced.

Preferably, the frontmost point of the elevation is arranged on the screw tip. As a result, the punching effect occurs directly when the screw is being screwed in, whereby splitting of very unstable or easily splittable material can be effectively avoided.

Preferably, the screw has two elevations extending towards the screw shaft on essentially opposite sides of the screw, starting, in each case, from at least one point of the respective elevation that is frontmost in a screw-in direction of the screw, each of the elevations having a course which corresponds to at least a part of an ellipse, and each ellipse being arranged in a plane which intersects the screw shaft at an angle of between 15 degrees and 75 degrees. As a result, the punching effect of the screw according to the invention is improved further.

According to the preferred embodiment of the screw according to the invention, the frontmost points of each of the elevations are arranged offset from each other in the screw-in direction of the screw. As a result, a gradual increase in the punching effect is achieved by the elevations. In addition, it is prevented in this way that an increased screw-in torque has to be overcome when the screw is attached.

The courses of the elevations can each form an ellipse that is open against the screw-in direction, or can each form an ellipse that is open in the screw-in direction. These configurations have the effect that dusty component material, such as, e.g., wood dust, will not accumulate within the ellipses, which could lead to an increased splitting effect and a higher screw-in torque. Alternatively, the elevations can have courses which correspond to complete ellipses.

The at least one frontmost point of at least one of the elevations is preferably arranged on the screw tip. As a result, the punching effect occurs directly when the screw is being screwed in, whereby splitting of very unstable or easily splittable material can be effectively avoided. The frontmost points of both elevations are preferably arranged on the screw tip.

According to the preferred embodiment variant of the screw according to the invention, the courses of the elevations intersect at crossing points which are arranged in one plane with a screw central axis running through the screw tip. In this way, the screw is prevented from wobbling during the screwing-in process. Alternatively, the courses of the elevations intersect at crossing points, with a connecting line through the crossing points being at a distance from a screw central axis running through the screw tip. As a result, wobble of the screw is induced during the screwing-in process, whereby the screw-in torque is reduced. According to a further alternative embodiment of the screw according to the invention, the elevations do not intersect.

The object of the invention is furthermore achieved by providing a rolling jaw which is designed for rolling out the screw according to the invention.

### BRIEF DESCRIPTION OF THE DRAWINGS

Advantageous embodiments of the screw according to the invention as well as alternative embodiment variants are explained in further detail below with reference to the figures.

FIG. 1a to FIG. 1c show a screw according to the invention with an elevation having a course in the form of half an ellipse which is arranged in a plane intersecting a screw shaft of the screw at a small angle. FIG. 1d shows a cross section through the screw according to FIG. 1a.

FIG. 2a to FIG. 2c show a screw according to the invention with an elevation having a course in the form of half an ellipse which is arranged in a plane intersecting the screw shaft of the screw at a larger angle. FIG. 2d shows a cross section through the screw according to FIG. 2a.

FIG. 3a to FIG. 3c show a screw according to the invention with an elevation having a course in the form of a complete ellipse which is arranged in a plane intersecting the screw shaft of the screw at a small angle. FIG. 3d shows a cross section through the screw according to FIG. 3a.

FIG. 4a to FIG. 4c show a screw according to the invention with an elevation having a course in the form of a complete ellipse which is arranged in a plane intersecting the screw shaft of the screw at a larger angle. FIG. 4d shows a cross section through the screw according to FIG. 4a.

FIG. 5a to FIG. 5c show a screw according to the invention with an elevation having a course in the form of a complete ellipse which is arranged in a plane intersecting the screw shaft of the screw at a small angle, with the elevation being offset along the screw shaft in comparison to the screw according to FIGS. 3a to 3d. FIG. 5d shows a cross section through the screw according to FIG. 5a.

FIG. 6a to FIG. 6c show a screw according to the invention with an elevation having a course in the form of a complete ellipse which is arranged in a plane intersecting the screw shaft of the screw at a larger angle, and is offset along the screw shaft in comparison to FIGS. 3a to 3d. FIG. 5d shows a cross section through the screw according to FIG. 5a.

FIG. 7a to FIG. 7c show a screw according to the invention with two elevations each having a course in the form of a complete ellipse which is arranged in a plane intersecting the screw shaft of the screw at a small angle. FIG. 7d shows a cross section through the screw according to FIG. 7a.

FIG. 8a to FIG. 8c show a screw according to the invention with two elevations each having a course in the form of a complete ellipse which is arranged in a plane intersecting the screw shaft of the screw at a larger angle. FIG. 8d shows a cross section through the screw according to FIG. 8a.

FIG. 9a to FIG. 9c show a screw according to the invention with two elevations each having a course in the form of half an ellipse which is opened against the screw-in direction, and which is arranged in a plane intersecting the screw shaft at a small angle. FIG. 9d shows a cross section through the screw according to FIG. 9a.

FIG. 10a to FIG. 10c show a screw according to the invention with two elevations each having a course in the form of half an ellipse which is opened against the screw-in direction, and which is arranged in a plane intersecting the screw shaft at a larger angle. FIG. 10d shows a cross section through the screw according to FIG. 10a.

FIG. 11a to FIG. 11c show a screw according to the invention with two elevations each having a course in the form of half an ellipse which is opened in the screw-in direction, and which is arranged in a plane intersecting the screw shaft at a small angle. FIG. 11d shows a cross section through the screw according to FIG. 11a.

FIG. 12a to FIG. 12c show a screw according to the invention with two elevations each having a course in the form of half an ellipse which is opened in the screw-in direction, and which is arranged in a plane intersecting the screw shaft at a larger angle. FIG. 12d shows a cross section through the screw according to FIG. 12a.

FIG. 13a to FIG. 13c show a screw according to the invention with two elevations each having a course in the form of a complete ellipse which is opened in the screw-in direction, and which is arranged in a plane intersecting the screw shaft at a small angle. FIG. 13d shows a cross section through the screw according to FIG. 13a.

FIG. 14a to FIG. 14c show a screw according to the invention with two elevations offset along the screw-in direction and each having a course in the form of half an ellipse which is opened against the screw-in direction. FIG. 14d shows a cross section through the screw according to FIG. 14a.

FIG. 15a shows a rolling jaw for rolling out the screw according to the invention in a perspective view, and FIG. 15b shows the rolling jaw according to FIG. 15a in a top view.

### DETAILED DESCRIPTION

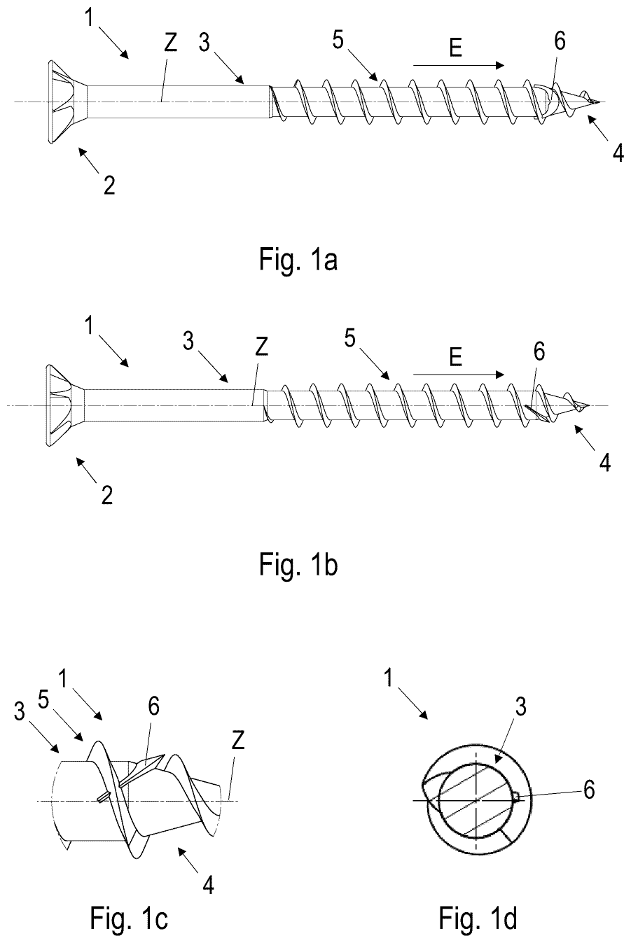

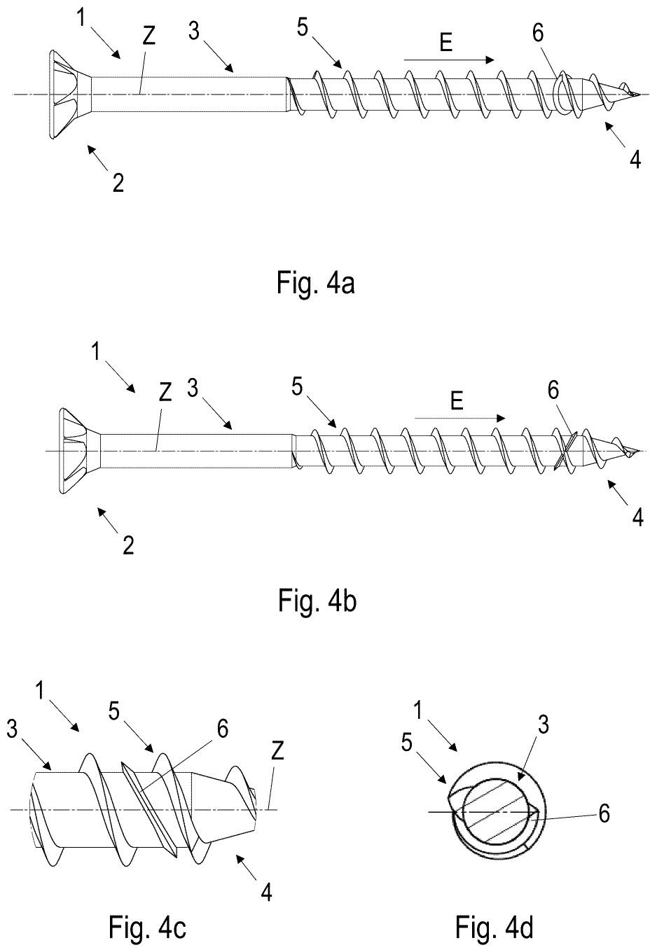

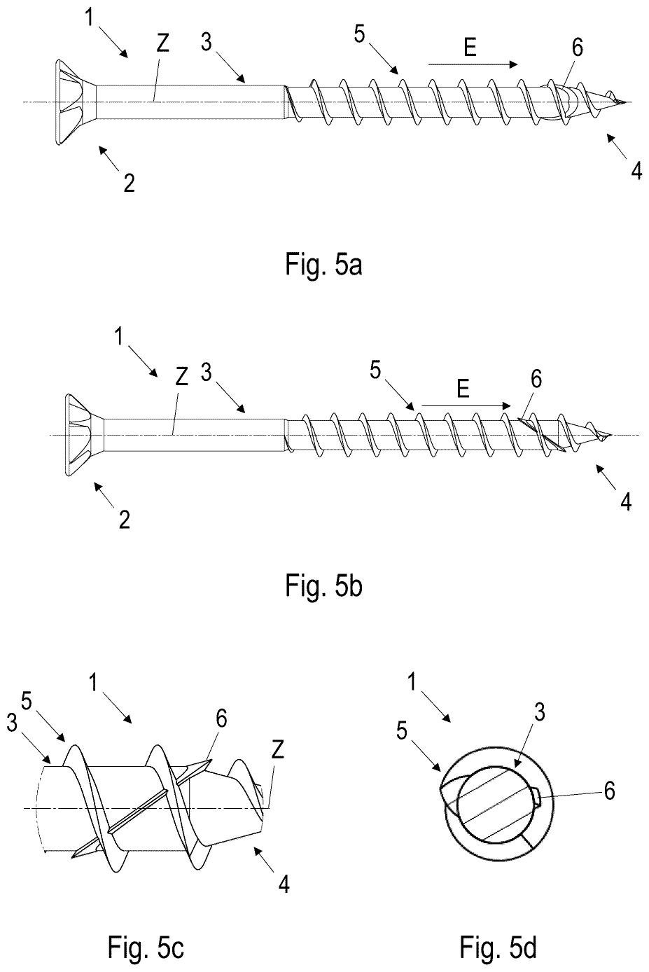

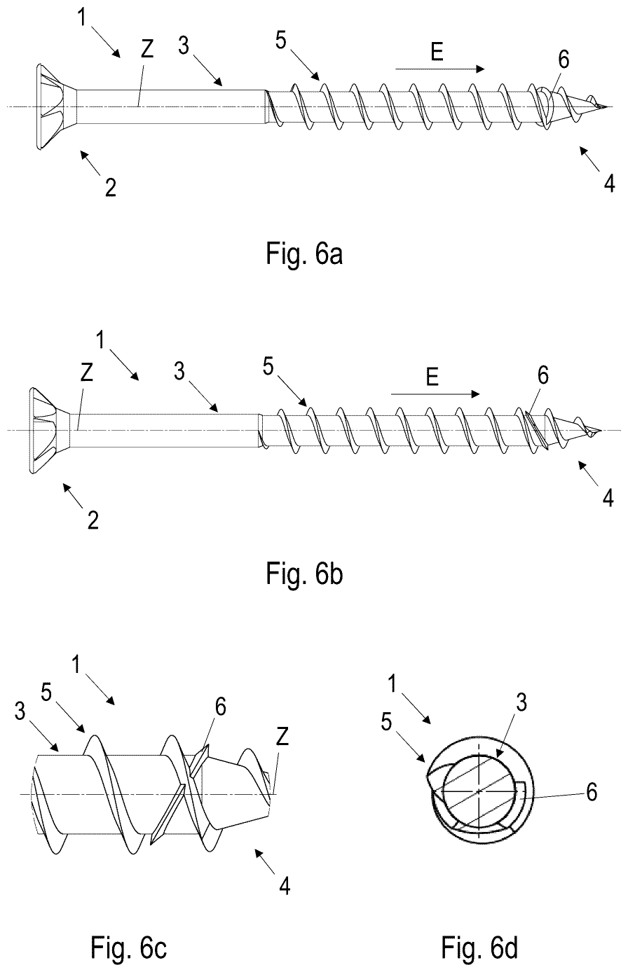

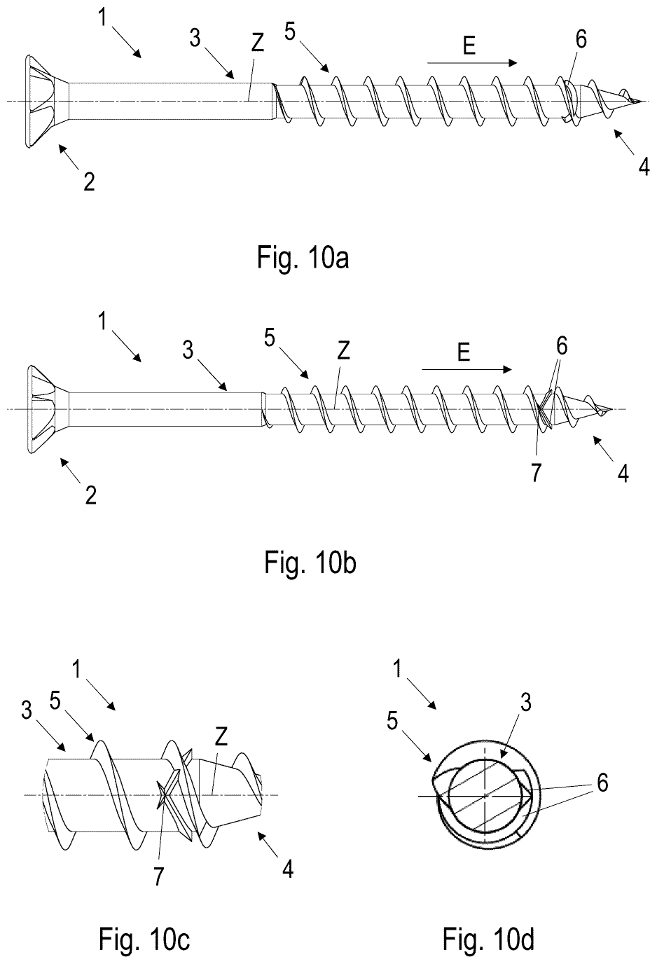

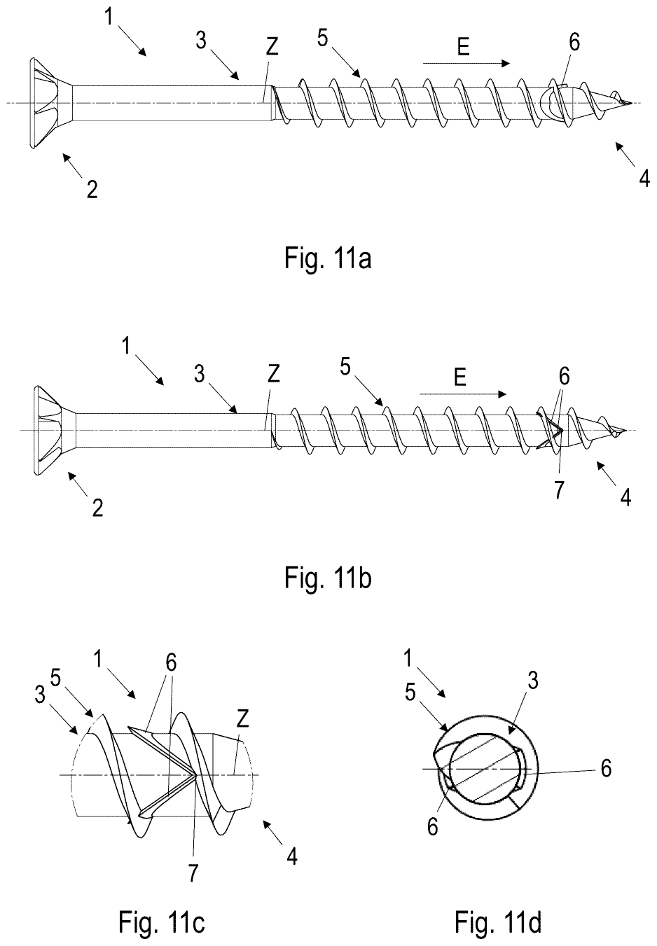

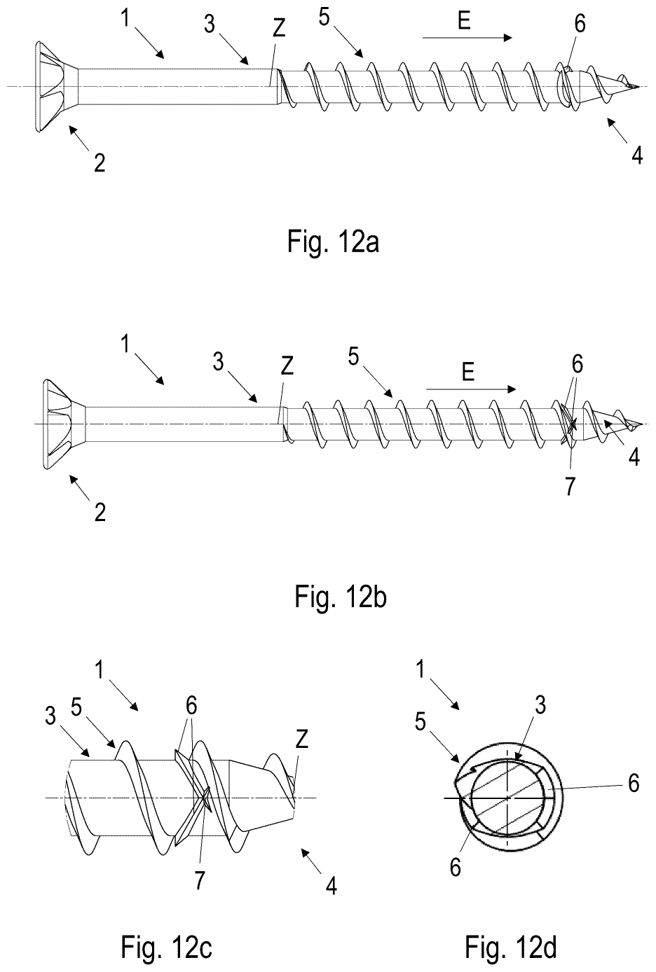

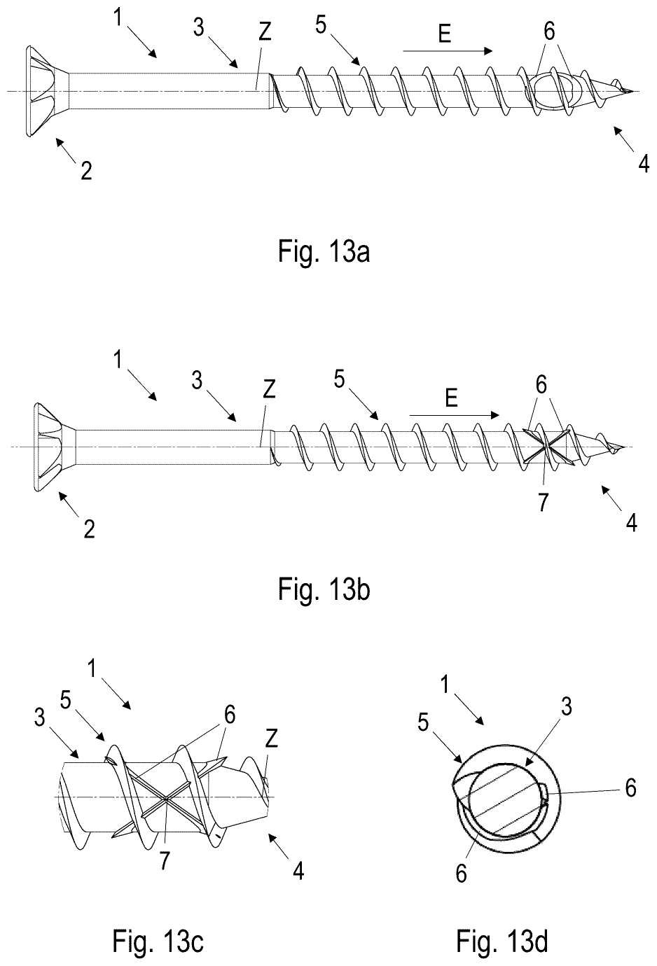

The screw 1 according to the invention is illustrated in different embodiment variants in FIGS. 1a to 14d, and comprises a screw head 2, a screw shaft 3 and a substantially conical screw tip 4. As is generally known to those skilled in the art of screws, the screw head 2 has a screw head drive (not shown in the figures) such as, for example, a cross screw, slotted, torx screw geometry. It serves for the application of a torque to the screw head 2 by means of an appropriate screw drive tool in order to screw the screw 1 according to the invention into a workpiece or component, which is not visible in the figures. Moreover, the screw 1 according to the invention has a thread 5 extending along the screw shaft 3 towards the screw head 2, starting from the screw tip 4. In this case, the thread 5 can run along the entire screw shaft 3, or, as can be seen in Fig. la and FIG. 1b, for example, it can run along the screw shaft 3 only in sections, starting from the screw tip 4. The screw 1 according to the invention is preferably a wood screw.

According to the invention, the screw 1 has at least one elevation 6 extending towards the screw shaft 3, starting from at least one point of the elevation 6 which is frontmost in a screw-in direction E of the screw 1, which is marked by an arrow in Fig. la. This elevation 6 is illustrated in detail in FIG. 1c, for example. FIG. 1d shows a cross section through the screw 1 in the area of the elevation 6. The elevation 6 has a course which corresponds to at least a section of an ellipse. In this case, the ellipse is arranged in a plane which intersects the screw shaft 3 at an angle of between 15 degrees and 75 degrees. In addition, a height of the elevation 6 is smaller than a height of the thread 5, as can be seen in FIG. 1d. The height of the thread is also referred to as the thread height or thread depth. This is the height with which the thread turns of the thread 5 stand out from the screw shaft 3 or, respectively, from the screw tip 4 at right angles to the screw-in direction E. The height of the elevation 6 denotes the height with which the elevation 6 stands out from the screw shaft 3 or, respectively, from the screw tip 4 at right angles to the screw-in direction E. According to an alternative embodiment variant, the ellipse can also be arranged in a plane which intersects the screw shaft 3 at an angle of between 30 degrees and 60 degrees.

Due to the course of the elevation 6 which is elliptical at least in sections and its inclination relative to the screw shaft 3 at an angle of between 15 degrees and 75 degrees, a punching effect is achieved when the screw 1 is screwed into a component material such as, for example, wood, and the necessary screw-in torque is reduced at the same time. This punching effect prevents too strong a splitting effect from acting on the component material as a result of the screw 1 being driven in. As a result, the component is effectively prevented from splitting as the screw 1 is being screwed in. Due to the smaller height of the elevation 6 in comparison to the height of the thread 5, the advantage is obtained that the thread 5 achieves a sufficient engagement depth for an effective forward thrust in the material of the component.

According to an embodiment variant of the screw 1 according to the invention, the course of the elevation 6 can form an ellipse that is open against the screw-in direction E. Alternatively, the course of the elevation 6 can also form an ellipse that is open in the screw-in direction E. In the screw 1 illustrated in FIGS. 1a to 1d, the course corresponds to half an ellipse that is open against the screw-in direction E. As a result, the advantage is obtained that dusty or, respectively, ground component material that has accumulated within the course of the elevation 6 is transported away.

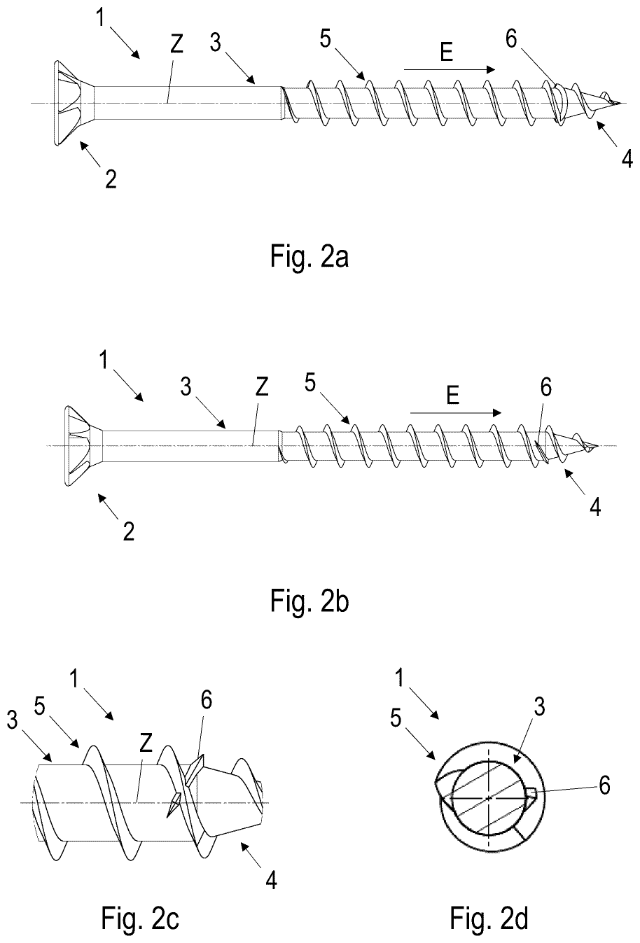

FIGS. 2a to 2d also show an embodiment variant of the screw 1 according to the invention in which the course of the elevation 6 corresponds to half an ellipse that is open against the screw-in direction E. However, in the embodiment variant of the screw 1 according to the invention as shown in FIGS. 2a to 2d, the ellipse of the course intersects the screw shaft 3 in a plane which is arranged at a larger angle than in the embodiment variant shown in FIGS. 1a to 2d. According to the invention, this angle is between 15 and 75 degrees.

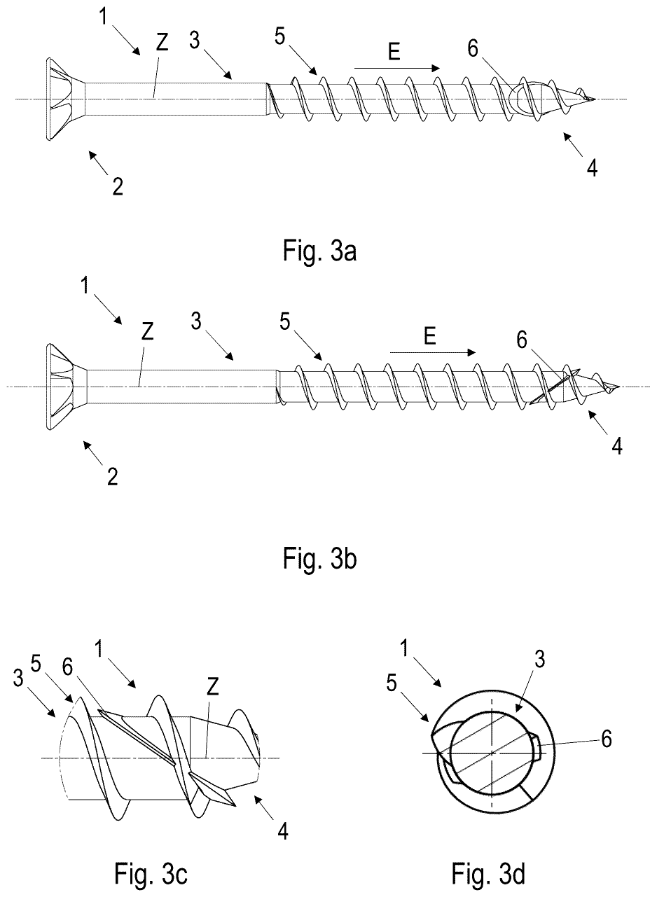

According to alternative embodiment variants shown in FIGS. 3a to 5d, the elevation 6 can also have a course which corresponds to a complete ellipse. As a result, the advantage is obtained that the punching effect arises more quickly and more uniformly along an entire circumference of the screw shaft 3 as the screw 1 is being screwed in. In addition, the frontmost point of the elevation 6 is preferably arranged on the screw tip 4. This can be seen, for example, in FIGS. 3b and 3c. This further increases the punching effect.

According to an alternative embodiment of the screw 1 according to the invention, the screw 1 has two elevations 6 extending towards the screw shaft 3 on essentially opposite sides of the screw 1, starting, in each case, from at least one point of the respective elevation 6 that is frontmost in a screw-in direction E of the screw 1, each of the elevations 6 having a course which corresponds to at least a part of an ellipse, and each ellipse being arranged in a plane which intersects the screw shaft 3 at an angle of between 15 degrees and 75 degrees.

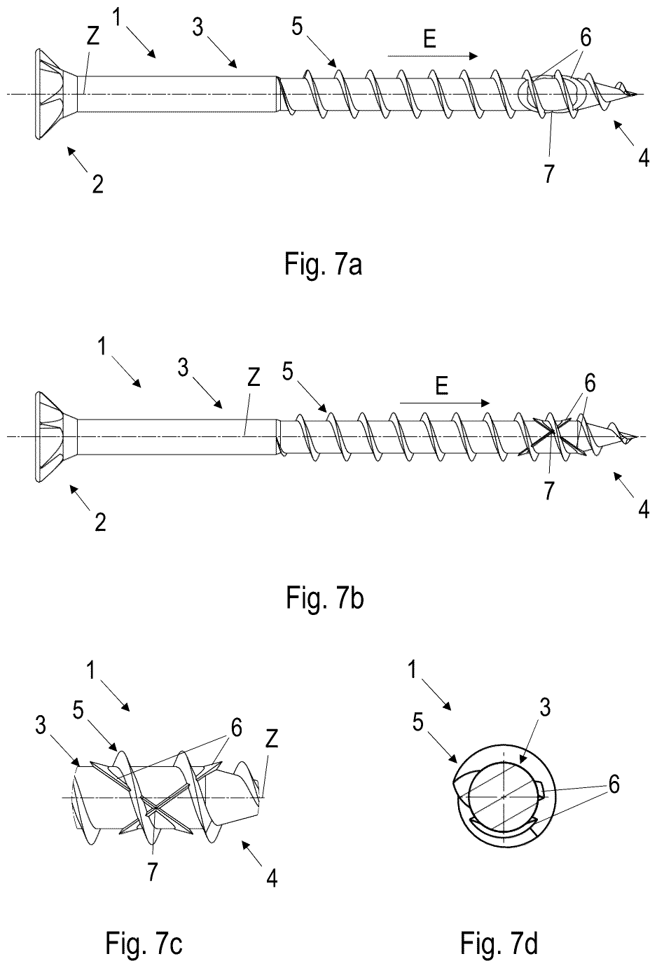

An embodiment variant of a screw 1 according to the invention that has been designed in such a way can be found, for example, in FIGS. 7a to 7d. Due to the two elevations 6, a stronger displacement of the material of the workpiece is achieved as the screw 1 is being screwed into a workpiece, whereby the punching effect is further improved. According to an alternative embodiment variant, the ellipses can, in each case, also be arranged in a plane which intersects the screw shaft 3 at an angle of between 30 degrees and 60 degrees. In general, angles between the plane and the screw shaft 3 of 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74 and 75 degrees are possible, for example.

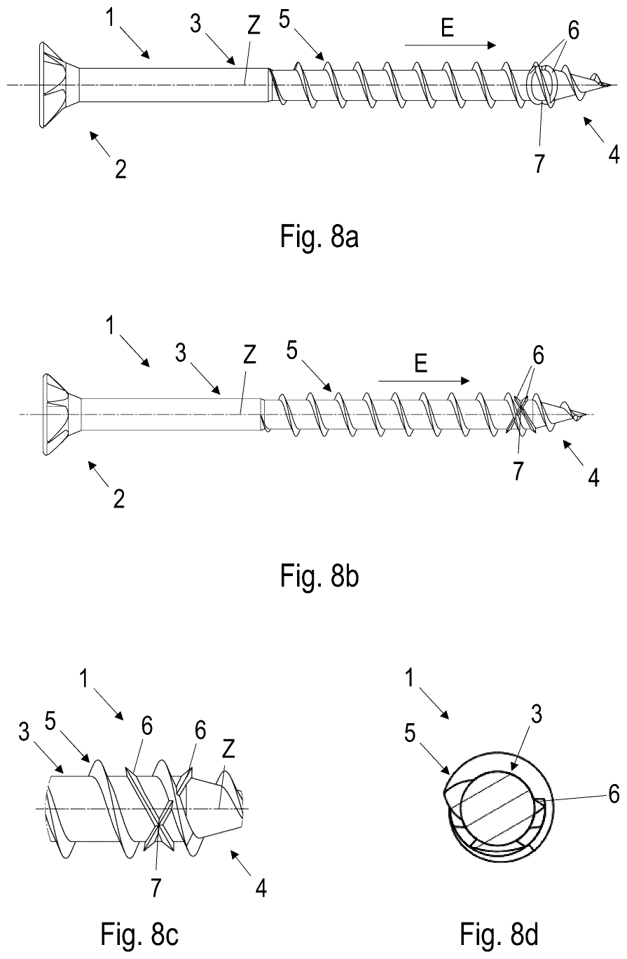

As can be gathered from the embodiment variant of the screw 1 according to the invention as illustrated in FIGS. 7a to 7d, the frontmost points of each of the elevations 6 can be arranged offset from each other in the screw-in direction E of the screw 1. In this way, the screw-in torque is prevented from increasing too strongly at a point along the screw-in direction E of the screw 1. Such a configuration can also be seen in the embodiment variant of the screw 1 according to the invention as illustrated in FIGS. 8a to 8d, with the angle of the planes in which the ellipses of the elevations are arranged being higher in this case than in the embodiment variant illustrated in FIGS. 7a to 7d.

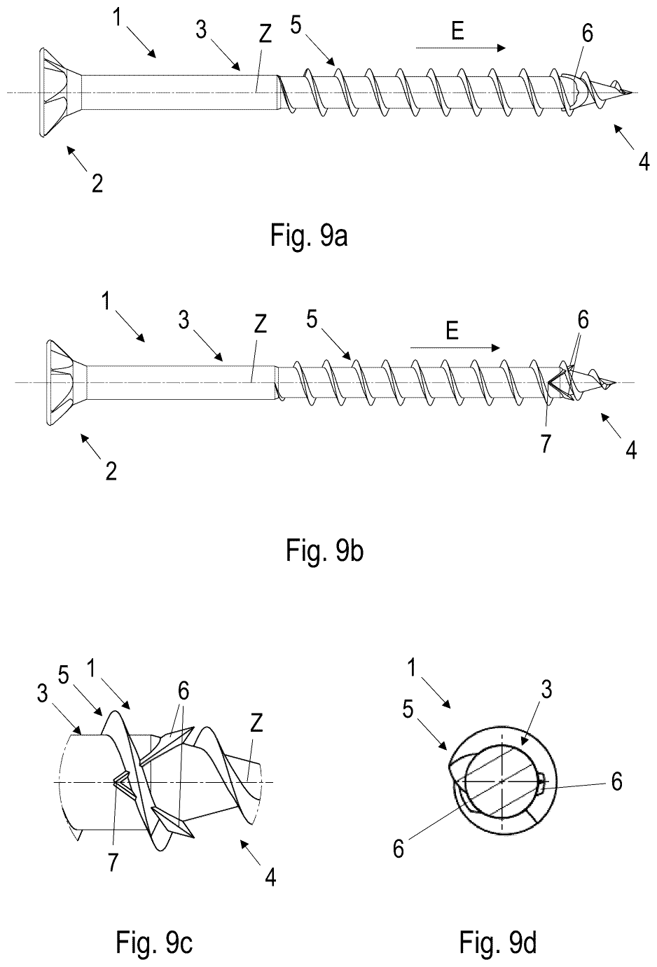

The courses of the elevations 6 can, in each case, form complete ellipses, as can be seen in FIGS. 7a to 8d. Alternatively, the courses of the elevations 6 can, in each case, form an ellipse that is open in the screw-in direction E or against the screw-in direction E. Screws 1 configured in this way can be seen in FIGS. 9a to 12d and 14a to 14d. This prevents stock material removed during the screwing-in process from accumulating within the ellipses, whereby screwing-in could be hampered.

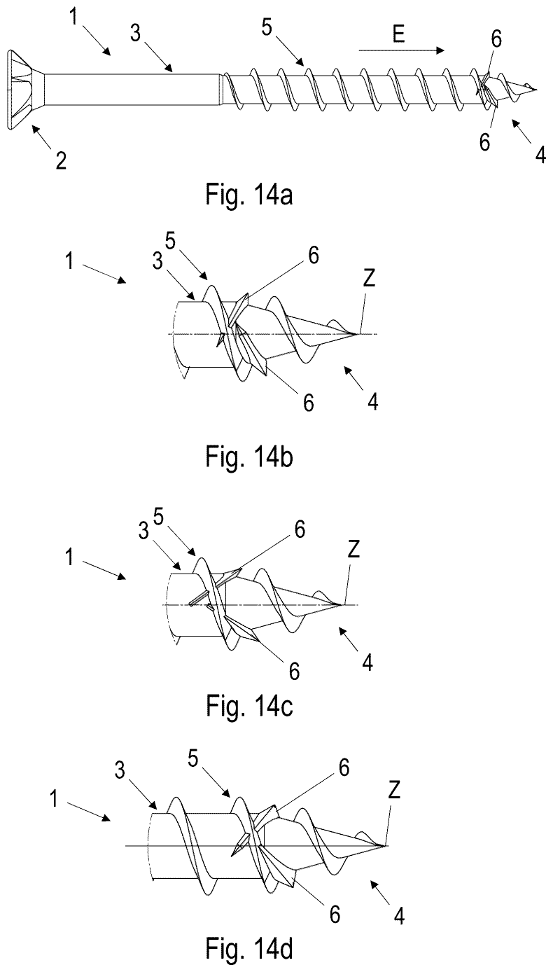

Preferably, the frontmost point of at least one or both of the elevations 6 is arranged on the screw tip 4. This can be seen, for example, in FIGS. 14a to 14d. What is achieved in this way is that the punching effect arises even with a small screw-in depth, whereby splitting of the stock material is effectively suppressed already during the first turns of the screw 1 in the material. In FIGS. 14a to 14d, both frontmost points of the elevations 6 are arranged on the screw tip 4.

According to an alternative embodiment variant, the courses of the elevations 6 intersect at crossing points 7 which are arranged in one plane with a screw central axis Z running through the screw tip 4. For example, the screws 1 according to the invention illustrated in FIGS. 9a to 13d are designed in this manner. According to a further alternative embodiment variant, the courses of the elevations 6 intersect at crossing points 7, with a connecting line through the crossing points 7 being at a distance from a screw central axis Z running through the screw tip 4. Screws 1 according to the invention designed in this manner can be seen, for example, in FIGS. 7a-8d and 14a to 14d. If the courses of the elevations 6 intersect at crossing points 7 which are arranged in one plane with a screw central axis Z running through the screw tip 4, fluctuations in the screw-in torque are avoided when screwing-in takes place. As a result, a uniform effort is achieved for a user of the screw 1 according to the invention when screwing-in takes place. If the courses of the elevations 6 intersect at crossing points 7, with a connecting line through the crossing points 7 being at a distance from a screw central axis Z running through the screw tip 4, a variable screw-in torque is achieved when screwing-in takes place. This leads to additional displacement of the stock material, whereby the pull-out torque is increased in comparison to the screw-in torque. According to a further alternative embodiment variant of the screw 1 according to the invention, the elevations 6 do not intersect. This can be seen, for example, in FIGS. 14a to 14c. The advantage is thus obtained that the removal of workpiece material from the elevations 6 is facilitated.

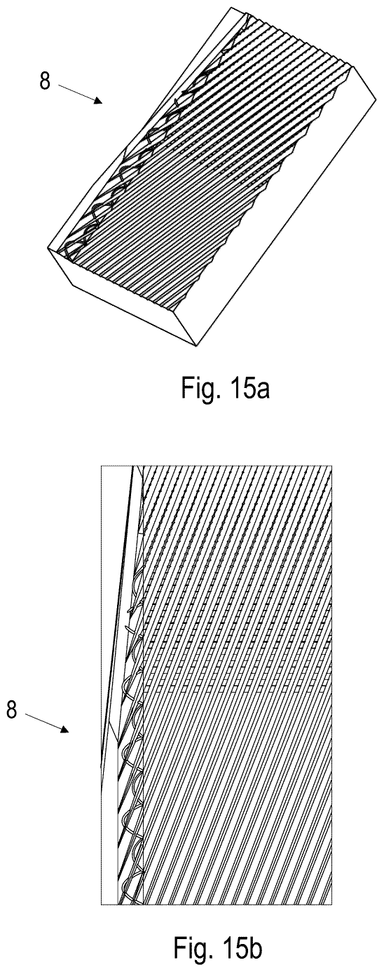

FIGS. 15a and 15b show a rolling jaw 8 according to the invention for rolling out the screw 1 according to the invention.

1-16. (canceled)

17. A screw comprising:
a screw head,
a screw shaft and
a substantially conical screw tip,
a thread extending along the screw shaft towards the screw head, starting from the screw tip, wherein
the screw includes at least one elevation extending towards the screw head, starting from at least one point of the elevation which is frontmost in a screw-in direction of the screw, and includes a course which corresponds to at least a section of an ellipse, the ellipse being arranged in a plane which intersects the screw shaft at an angle of between 15 degrees and 75 degrees, and with a height of the elevation being smaller than a height of the thread.

18. The screw according to claim 17, wherein the course of the elevation forms an ellipse that is open against the screw-in direction.

19. The screw according to claim 17, wherein the course of the elevation forms an ellipse that is open in the screw-in direction.

20. The screw according to claim 17, wherein the elevation has a course which corresponds to a complete ellipse.

21. The screw according to claim 17, wherein the frontmost point of the elevation is arranged on the screw tip.

22. The screw according to claim 17, wherein the screw has two elevations extending towards the screw head on essentially opposite sides of the screw, starting, in each case, from at least one point of the respective elevation that is frontmost in a screw-in direction of the screw, each of the elevations having a course which corresponds to at least a part of an ellipse, and each ellipse being arranged in a plane which intersects the screw shaft at an angle of between 15 degrees and 75 degrees.

23. The screw according to claim 22, wherein the frontmost points of each of the elevations are arranged offset from each other in the screw-in direction of the screw.

24. The screw according to claim 22, wherein the courses of the elevations each form an ellipse that is open against the screw-in direction.

25. The screw according to claim 22, wherein the courses of the elevations each form an ellipse that is open in the screw-in direction.

26. The screw according to claim 22, wherein the elevations have courses which correspond to complete ellipses.

27. The screw according to claim 22, wherein the at least one frontmost point of at least one of the elevations is arranged on the screw tip.

28. The screw according to claim 22, wherein the frontmost points of both elevations are arranged on the screw tip.

29. The screw according to claim 22, wherein the courses of the elevations intersect at crossing points which are arranged in one plane with a screw central axis running through the screw tip.

30. The screw according to claim 22, wherein the courses of the elevations intersect at crossing points, with a connecting line through the crossing points being at a distance from a screw central axis running through the screw tip.

31. The screw according to claim 22, wherein the elevations do not intersect.

32. A rolling jaw, wherein the rolling jaw is configured for rolling out a screw according to claim 17.

33. A rolling jaw, wherein the rolling jaw is configured for rolling out a screw according to claim 22.
